(19) United States
(12) Patent Application Publication
(10) Pub. No.: US 2005/0188275 A1
(43) Pub. Date: Aug. 25, 2005

(54) Systems and methods for error tracking and recovery in an expectation-based memory agent checker

(76) Inventors: John Warren Maly, Laporte, CO (US); Ryan Clarence Thompson, Loveland, CO (US); Zachary Steven Smith, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/770,741

(22) Filed: Feb. 3, 2004

(51) Int. Cl. G06F 11/00

(52) U.S. Cl. 714/39

(57) ABSTRACT

Systems, methods and software products are provided for error tracking and recovery in an expectation-based memory agent checker. An electronic device design is simulated with stimuli of one or more test cases, to generate simulated output transaction events. The simulated output transaction events are compared with expected output transaction events. Remaining expected output transaction events for a transaction are identified based upon mismatch between (a) at least one of the simulated output transaction events of the transaction and (b) the expected output transaction events of the transaction.

### RELATED APPLICATIONS

This application is related to the following commonly owned and co-filed U.S. patent application, filed Feb. 3, 2004 and incorporated herein by reference: Transaction logging and intelligent error reporting in an expectation-based memory agent checker (Attorney Docket 200208665-1).

### BACKGROUND

Semiconductor technology has advanced at a high rate over the past several decades, resulting in electronic devices with enormous complexity, such as very large scale integration (VLSI) processors. Each such electronic device typically consists of a large number of diverse subsystems; the interaction between these subsystems is also very complex. The likelihood of design errors within the electronic device increases with increased interaction between the subsystems. Accordingly, the cost of converting an electronic device design into a physical device still remains very high since a design error present in the physical device is very costly to correct.

Elimination of design errors as early as possible in a design cycle of the electronic device helps minimize the overall design period and also reduces associated development costs. Interaction between subsystems of the electronic device design is thus extensively tested prior to committing the electronic device design to physical form. In one example of this testing, subsystems of the electronic device design are repeatedly simulated to test the interaction between the subsystems, and between the subsystems and external devices, to identify design errors.

Though it is desirable to test as many of these interactions as possible, the amount of testing is limited by time and cost. Therefore, any increase in the efficiency of testing, and/or in the computer aided design (CAD) tools that facilitate this testing, results in improved device reliability and/or reduced development time and cost.

In addition, the latest generation of processors include a particularly diverse range of subsystems that require improved design and development techniques. For example, modern high performance multi-core processors (such as the Hewlett Packard/Intel “Montecito” processor) represent ultra-complex integrated circuit design and, as such, challenge CAD tools and development techniques. Extensive testing is thus required, particularly prior to reducing the multi-core processor design to physical form.

Within the multi-core processor, memory agents handle memory operations or transactions that access memory (e.g., shared memory and caches). For example, a processor core may read a line of memory stored in one or more locations within the multi-core processor, such as in the shared memory and caches. The memory agents cooperate to determine the source from which the line of memory should be read for the multi-core processor.

The memory agents, shared memory and caches may connect in a number of ways, such as by a bus or by a point to point link using a suitable protocol. A single memory transaction may therefore be quite complex, involving transmission of requests and data back and forth among the memory agents, shared memory and caches. The sequence of transmissions depends upon the locations and states of the line of memory and the bus protocol employed. Testing the operation of the memory agents is an extremely complex and data-intensive procedure.

A point to point link is a switch-based network that may have one or more crossbars that act as switches between the memory agents, shared memories, the processing cores, and other devices. Transactions on the point to point link are packet-based; each packet has a header with routing and other information. Information within the transactions is thus directed to specific locations within the multi-core processor and are routed appropriately by the crossbars.

FIG. 1 is a flowchart illustrating one prior art process 100 for testing, modifying and re-testing an electronic device design prior to committing the electronic device design to physical form. In step 102, process 100 creates one or more test cases for the electronic device design. Each test case typically employs one or more stimuli, used during simulation of the electronic device design, and one or more predicted outputs (‘expectations’). In one example, step 102 is performed by a design engineer who creates one or more tests for the electronic device design. In another example, step 102 is performed automatically by an Electronic Computer Aided Design (E-CAD) analysis tool that processes the electronic device design to produce the test cases.

In step 104, process 100 simulates the electronic device design and performs the tests of step 102. For example, in step 104, circuitry of all or part of the electronic device design is entered into an E-CAD simulation tool. The simulation uses the stimuli of each test case (from step 102) to produce simulation output.

In step 106, process 100 compares simulation output of step 104 to the predicted output of step 102, and logs results for each test case. Step 106 may, for example, send error messages to an engineering design terminal to indicate detected errors. In one example of step 106, process 100 compares, for each test case, simulation output of step 104 to predicted output of step 102, indicating that the test is successful if the simulation output matches the predicted output. If, in step 106, process 100 determines that an unexpected event occurred during simulation step 104, process 100 indicates that incorrect operation of one or more subsystems of the electronic device design has occurred. In another example of step 106, process 100 does not receive a predicted event of step 102, again indicating incorrect operation of one or more subsystems of the electronic device design. In another example of step 106, process 100 determines that the simulation output does not match the predicted output of step 102, again indicating incorrect operation of one or more subsystems of the electronic device design.

Step 108 is a decision. In step 108, if one or more errors are detected in step 106, process 100 continues with step 110; otherwise process 100 terminates, indicating that testing of the electronic device design is complete and that the electronic device design operates correctly. If no errors are detected in step 108, for example, process 100 terminates and indicates that the electronic device design is ready for manufacture. In step 110, process 100 modifies the electronic device design to correct errors detected in step 106, or, in certain cases, modifies the expected output, determined in step 102, to change error definitions.

Steps 104, 106, 108 and 110 are typically repeated many times, each iteration correcting problems identified in the electronic device design and/or test cases. When no errors are detected in step 106, the electronic device design is considered to operate correctly for all test cases created in step 102. If no further testing of the electronic device design is required, process 100 terminates and the electronic device design is committed to physical form.

Once the device is manufactured, it is again tested for correct operation and, if successful, the electronic device is often mass produced. If further errors are detected, the electronic device design may again be modified 110 in process 100 and then re-tested with additional test cases.

During operation of process 100, one design error typically causes many test errors, often resulting in duplicate and bogus error indications. Where the test case simulates interaction between one or more subsystems, a design error within one subsystem may therefore result in a plurality of cascaded error messages from process 100. These cascaded error messages (including repeated error messages) may obscure real errors in the system. A verification engineer is therefore required to carefully search through all reported errors to identify the real errors. This searching is difficult and time consuming, resulting in additional development time and cost.

Design modification step 110 of process 100 may thus require extensive analysis of transaction and error logs to identify real errors in the electronic device design. This transaction and error log analysis is often very labor intensive and can occur many times during the development of the electronic device design. The large number of transaction and error log messages created during simulation of the electronic device design makes it difficult for the verification engineer to identify fundamental causes of error, resulting in development delays and increased development costs. In one example, the verification engineer manually traces back through many hundreds of transaction and error log messages to determine fundamental causes of error in memory agent transactions. Further, the error messages and logging information typically produced by process 100 are both voluminous and cryptic, requiring skilled interpretation.

### SUMMARY OF THE INVENTION

In one embodiment, a method is provided for error tracking and recovery in an expectation-based memory agent checker. An electronic device design is simulated with stimuli of one or more test cases, to generate simulated output transaction events. The simulated output transaction events are compared with expected output transaction events. Remaining expected output transaction events for a transaction are identified based upon mismatch between (a) at least one of the simulated output transaction events of the transaction and (b) the expected output transaction events of the transaction.

In another embodiment, a method is provided for error tracking and recovery in an expectation-based memory agent checker. An electronic device design is simulated with stimuli of one or more test cases to simulate a transaction. The simulated events of the transaction are observed. The simulated events are sequentially compared with expected transaction events of the transaction. If a mismatch occurs: one error message for the mismatch is generated; remaining expected events for the transaction are identified; if possible, unmatched simulated events are matched to the identified remaining expected events; if possible, simulated events for a next transaction are matched to expected events for the next transaction without comparison to the identified remaining expected events.

In another embodiment, a system is provided for error tracking and recovery in an expectation-based memory agent checker. One or more test cases contain stimuli. An expectation generator generates expected events based upon observed simulation events. A simulator simulates an electronic device design and generates simulated output transaction events. A result checker (a) compares simulated output transaction events and expected output transaction events, (b) identifies remaining expected output transaction events for a transaction when a mismatch occurs between the simulated output transaction events and expected output transaction events for the transaction, and (c) generates an error message for the mismatch. A transaction and error log stores the error message.

In another embodiment, a system is provided for error tracking and recovery in an expectation-based memory agent checker, including: means for stimulating an electronic device design with stimuli of one or more test cases, to generate simulated output transaction events; means for comparing the simulated output transaction events with expected output transaction events; and means for identifying remaining expected output transaction events for a transaction based upon mismatch between (a) at least one of the simulated output transaction events of the transaction and (b) the expected output transaction events of the transaction.

In another embodiment, a software product has instructions, stored on computer-readable media, wherein the instructions, when executed by a computer, perform steps for error tracking and recovery in an expectation-based memory agent checker, including: instructions for stimulating a simulated electronic device design with stimuli of one or more test cases, to generate simulated output transaction events; instructions for comparing the simulated output transaction events with expected output transaction events; and instructions for identifying remaining expected output transaction events for a transaction based upon mismatch between (a) at least one of the simulated output transaction events of the transaction and (b) the expected output transaction events of the transaction.

### BRIEF DESCRIPTION OF THE FIGURES

FIG. 1 is a flowchart illustrating a prior art design process for testing an electronic device design.

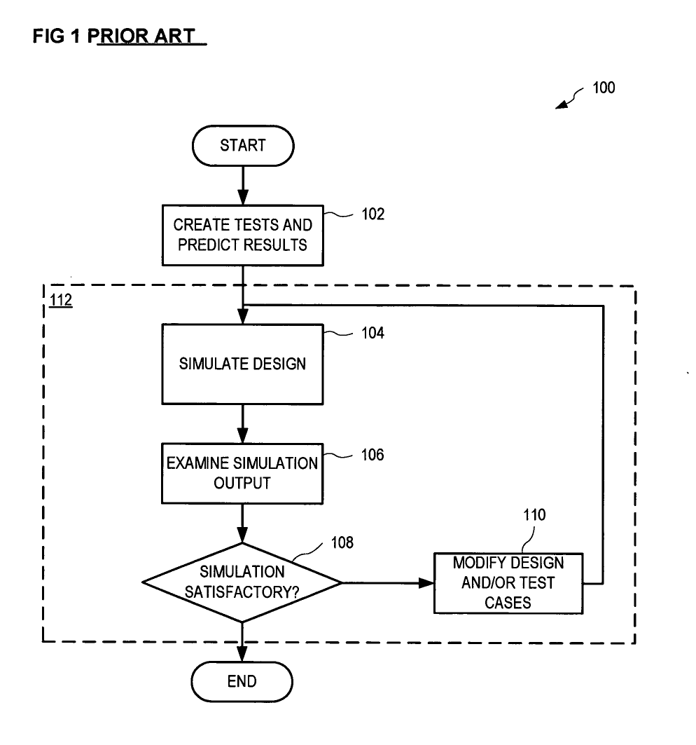

FIG. 2 is a block diagram illustrating one system for error tracking and recovery in an expectation-based memory agent checker.

FIG. 3a is a block diagram illustrating exemplary data flow and logic control during simulation and verification of an electronic device design by cooperation of the simulator and the checker of FIG. 2.

FIG. 3b is a block diagram illustrating exemplary simulated and expected transaction events.

FIG. 3b is a block diagram illustrating simulated and expected transaction events that include an error.

FIG. 4a is a flowchart illustrating one process for error tracking and recovery in an expectation-based memory agent checker.

FIG. 4b is a flowchart illustrating one sub-process of FIG. 4a.

FIG. 5 is a flowchart illustrating one process for error tracking and recovery in an expectation-based memory agent checker.

### DETAILED DESCRIPTION OF THE FIGURES

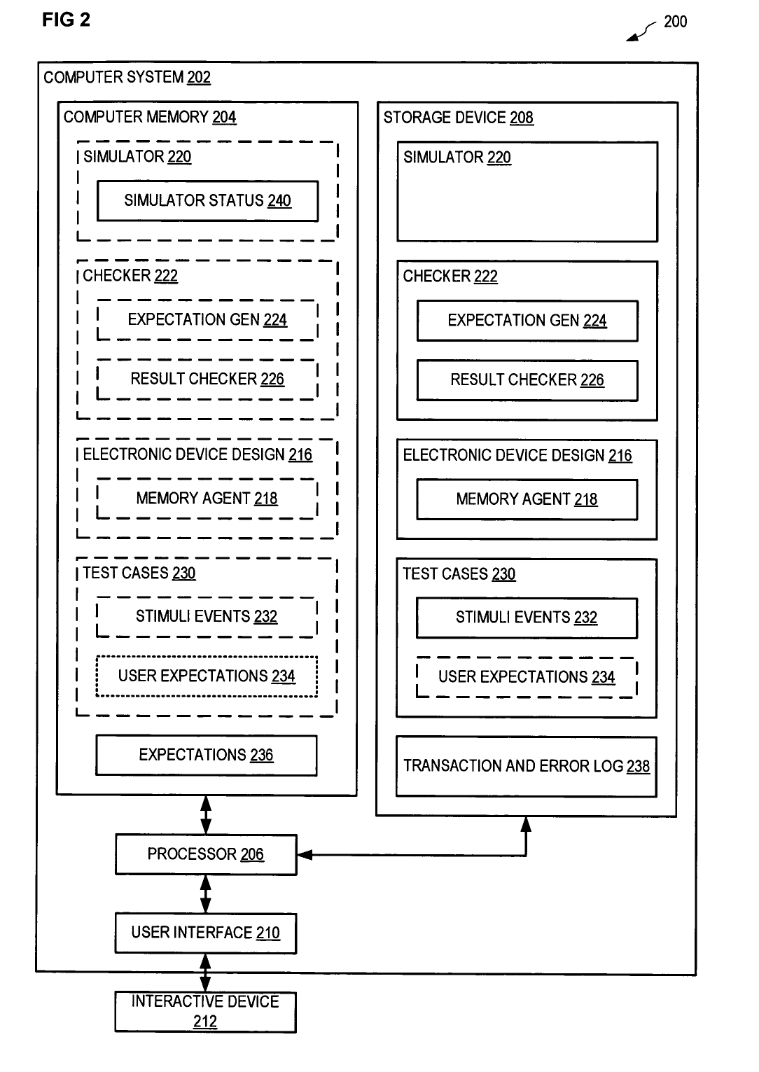

FIG. 2 is a block diagram illustrating one system 200 for error tracking and recovery in an expectation-based memory agent checker. System 200 has a computer 202 with a computer memory 204, a processor 206, a storage device 208, and a user interface 210. System 200 also includes an interactive device 212 connected to user interface 210 of computer 202. Interactive device 212 is, for example, a computer terminal used by a verification engineer to interact with computer 202. Storage device 208 is, for example, a disk drive that stores software and data of computer 202.

Storage device 208 is shown with a simulator 220, a checker 222, an electronic device design 216 and test cases 230. Simulator 220, checker 222, electronic device design 216 and test cases 230 are loaded into computer memory 204 by processor 206 such that simulator 220 and checker 222 are executable by processor 206. Simulator 220, checker 222, electronic device design 216 and test cases 230 are therefore shown in dashed outline in computer memory 204 for purposes of illustration. Electronic device design 216 is, for example, a very large scale integration (VLSI) circuit design of an electronic device that includes a memory agent 218. Memory agent 218 handles memory operations, or transactions that access memory (e.g., shared memory and caches), of electronic device design 216.

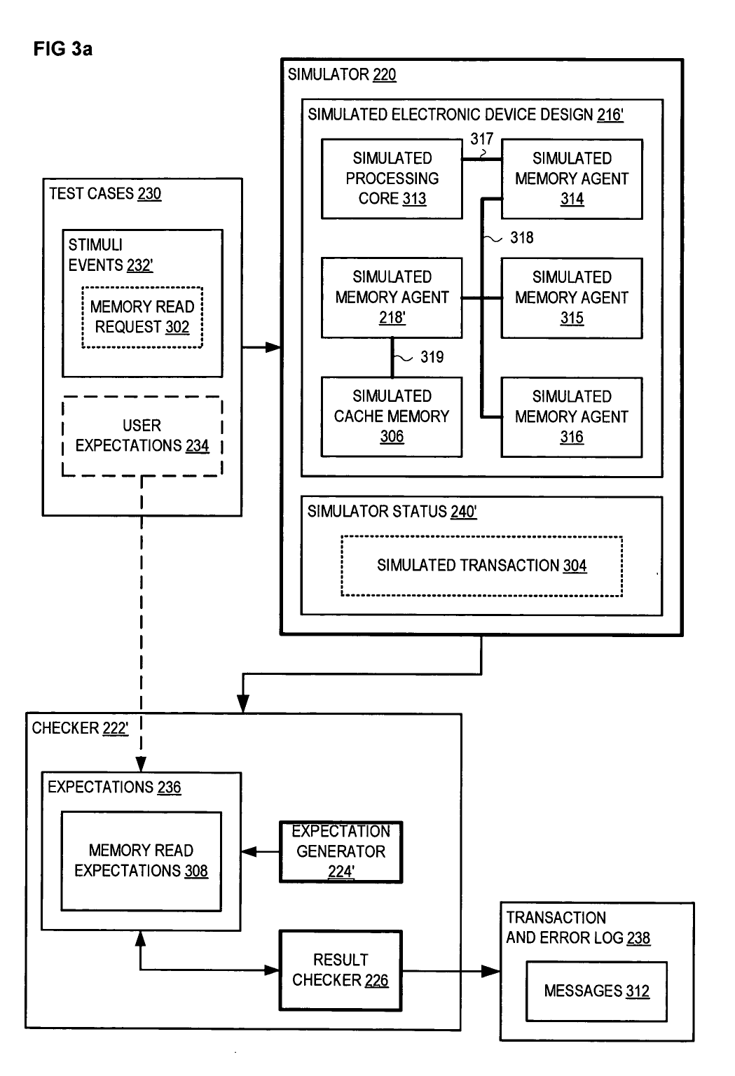

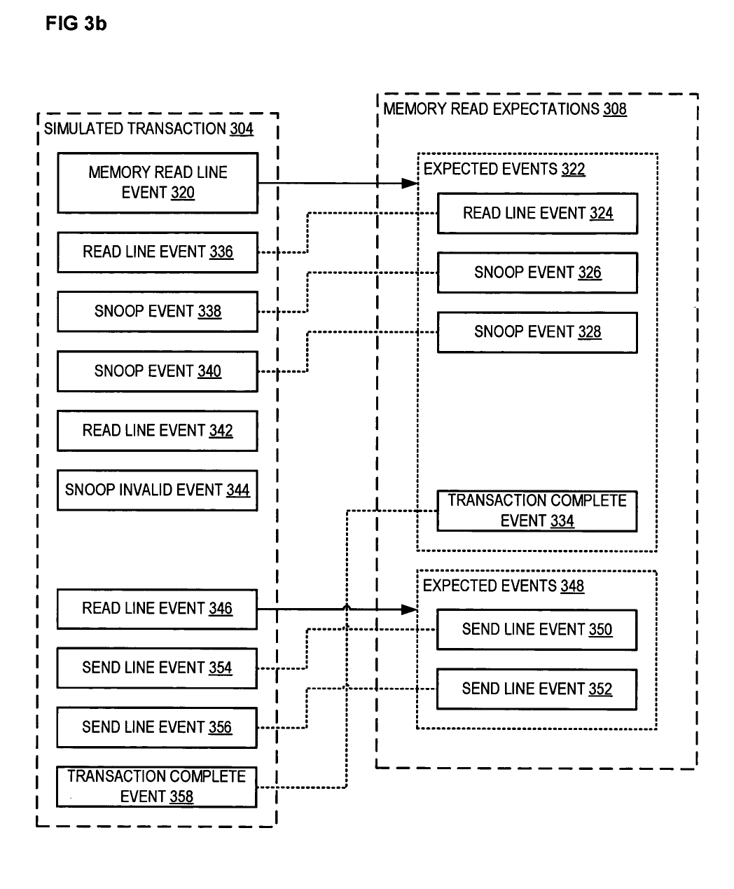

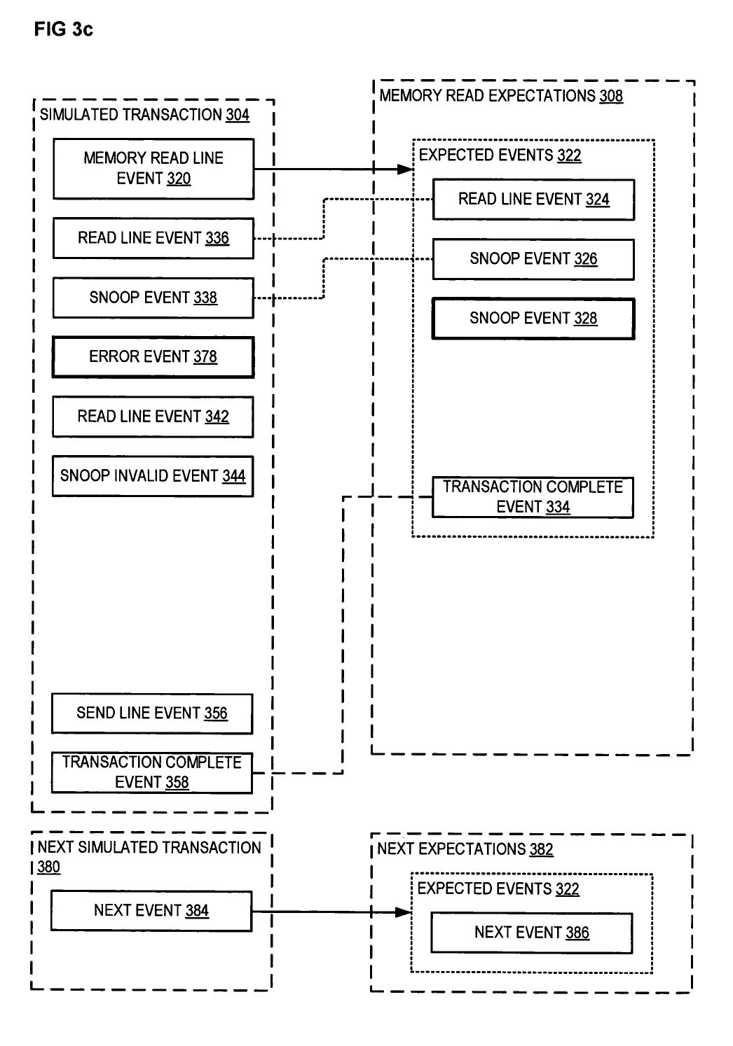

In operation, simulator 220 and checker 222 cooperate to test electronic device design 216, using test cases 230 to produce transaction and error log 238. In particular, simulator 220 first simulates electronic device design 216 (such as shown in FIG. 3a), then stimulates the simulated electronic device design 216 using test cases 230. Checker 222 then observes simulator status 240 to verify correct operation of memory agent 218, producing transaction and error log 238.

By way of illustrative operation, a verification engineer utilizes interactive device 212 to instruct simulator 220 and checker 222, through user interface 210, to test electronic device design 216. Test cases 230 include stimuli events 232 that are used by simulator 220 to stimulate electronic device design 216. In one example, stimuli events 232 are processor instructions for simulated execution by processing cores of electronic device design 216 to stimulate memory agent 218. Checker 222 includes an expectation generator 224 that generates expectations 236, stored in computer memory 204, as shown. Expectations 236 define expected output events of memory agent 218 during simulation of electronic device design 216 using stimuli events 232. Optionally, test cases 230 may include user expectations 234 that are created by one or more verification engineers, to define expected output of memory agent 218 during simulation of electronic device design 216; user expectations 234 may be loaded into expectations 236.

Checker 222 observes simulator status 240 and utilizes a result checker 226, illustratively shown within checker 222, to compare output events of memory agent 218 against expectations 236 and generate transaction and error log 238, illustratively shown in storage device 208. Result checker 226 may also modify expectations 236 to enable error tracking and recovery, thereby preventing unwanted and duplicate error messages from being written to transaction and error log 238. Transaction and error log 238 may also be output to other devices external to computer 202, for example, to interactive device 212.

FIG. 3a is a block diagram illustrating exemplary data flow and logic control during simulation of electronic device design 216 by simulator 220, FIG. 2, and observation of simulator status 240′ by checker 222, FIG. 2. FIG. 3b is a block diagram illustrating exemplary simulated transaction events of simulated transaction 304 and exemplary expected transaction events of memory read expectations 308 that result from memory read request 302. FIGS. 3a and 3b are best viewed together with the following description.

In FIG. 3a, simulator 220 is illustratively shown with a simulated electronic device design 216′ and simulator status 240′. Simulated electronic device design 216′ includes simulated memory agents 218′, 314, 315, 316, a simulated cache memory 306 and a simulated processing core 313. Simulated memory agents 218′, 314, 315, 316 communicate through a simulated point to point link 318; simulated memory agent 218′ communicates with simulated cache memory 306 via a simulated communication link 319; and simulated processing core 313 communicates with simulated memory agent 314 via a simulated communication link 317. Simulated memory agent 314 is, for example, a memory agent of simulated processing core 313. Simulated memory agents 315 and 316 are, for example, memory agents of other processing cores (not shown) within simulated electronic device design 216′. In this example, simulated memory agent 218′ is tested by checker 222′.

A memory read request 302, of stimuli events 232, is used to stimulate simulated electronic device design 216′. In one example, memory read request 302 is a processor instruction that, when executed by simulated processing core 313, causes simulated processing core 313 to read a line of memory within simulated cache memory 306, initiating a simulated transaction 304 between simulated memory agent 218′ and simulated cache memory 306 via communication link 319. FIG. 3b illustrates events of simulated transaction 304. In particular, simulated processing core 313 causes simulated memory agent 314 to generate a memory read line event 320 that is sent from simulated memory agent 314 to simulated memory agent 218′, via point to point link 318, thus initiating simulated transaction 304.

In testing simulated memory agent 218′, checker 222′ observes simulator status 240′ to identify events associated with simulated memory agent 218′. In particular, checker 222′ observes memory read line event 320 and utilizes expectation generator 224′ to generate expected events 322 within memory read expectations 308. In the example, expectation generator 224′ has knowledge of simulated processing core 313 and simulated memory agents 218′, 314, 315 and 316. Expectation generator 224′ therefore generates four expected events within expected events 322: a read message event 324 that simulated memory agent 218′ expects to send to simulated cache memory 306; a snoop event 326 that simulated memory agent 218′ expects to send to simulated memory agent 315; a snoop event 328 that simulated memory agent 218′ expects to send to simulated memory agent 316; and a transaction complete event 334 that simulated memory agent 218′ expects to send to simulated memory agent 314.

Snoop events 326 and 328 are generated by simulated memory agent 218′ to request the line of memory from simulated memory agents 315, 316, since the line of memory may be modified and stored in other memories (not shown) associated with simulated memory agents 315, 316. Note that, in the example, expectation generator 224′ does not predict responses to snoop events 326 and 328. However, expectation generator 224′ may operate to predict responses to snoop events 326 and 328 and/or user expectations 234 may define expected events of simulated transaction 304 and are input to expectations 236.

Continuing with the example, checker 222′ next observes read line event 336, generated by simulated memory agent 218′, within simulated transaction 304 and utilizes result checker 226 to match read line event 336 to read line event 324 within memory read expectations 308. Once matched, expected events are removed from memory read expectations 308. Checker 222′ next observes snoop events 338, 340, which result checker 226 matches to snoop events 326, 328, respectively. Checker 222′ then observes read line event 342, sent by simulated cache memory 306 and containing the contents of the requested line of memory. Upon receiving read line event 342, simulated memory agent 218′ stores the contents of the line of memory internally, and waits for responses to snoop events 326, 328 to learn if the value of the line of memory is current. Checker 222′ next observes snoop invalid event 344, sent by simulated memory agent 315 to indicate that the line of memory, requested by snoop event 338, is not stored in memory associated with simulated memory agent 315. Since expectation generator 224′ does not generate expectations for snoop events 338, 340, in this example, snoop invalid event 344 is not matched to events of memory read expectations 308.

Checker 222′ next observes read line event 346, sent by simulated memory agent 316 and containing a modified value for the line of memory. In one example of operation, in response to snoop event 338, simulated memory agent 316 retrieves a modified value of the line of memory from memory cache associated with simulated memory agent 316. Checker 222′ recognizes read line event 346 as an input to simulated memory agent 218′ and therefore utilizes expectation generator 224′ to generate expected events 348 resulting from read line event 346. Since simulated memory agent 316 responded with a modified value for the line of memory, expectation generator 224′ generates (a) a send line event 350, since simulated memory agent 218′ is expected to send the modified value of the line of memory to simulated cache memory 306 (to update the value of the line of memory within simulated memory cache 306), and (b) a send line event 352, since simulated memory agent 218′ is expected to send the modified value of the line of memory to simulated memory agent 314.

Checker 222′ next observes send line event 354, sent by simulated memory agent 218′ to simulated cache memory 306 and containing the modified value of the line of memory; and result checker 226 matches send line event 354 to send line event 350. Checker 222′ next observes send line event 356, sent by simulated memory agent 218′ to simulated memory agent 314. Send line event 356 contains the modified value of the line of memory received from simulated memory agent 316 in read line event 346. Result checker 226 matches send line event 356 to send line event 352 of expectations 236. Checker 222′ next observes transaction complete event 358, sent by simulated memory agent to 218′ simulated memory agent 314, to terminate simulated transaction 304. Result checker 226 matches transaction complete event 358 to transaction complete event 334, and thus determines that simulated transaction 304 successfully completes. In this example, memory agent 218′ attaches the modified value of the line of memory to the transaction complete event 334. Result checker 226 may write an appropriate message (e.g., message 312) to transaction and error log 238 indicating the success of simulated transaction 304.

Using the example of FIGS. 3a and 3b, FIG. 3b illustrates one exemplary scenario of an error event 378 occurring in place of expected snoop event 328, FIG. 3b. In the example of FIG. 3c, checker 222′ observes memory read line event 320 and uses expectation generator 224′ to generate expected events 322. Simulated transaction 304 and events 336 and 338 are observed and matched, respectively, by checker 222′ and result checker 226.

In the example of FIG. 3c, checker 222′ then observes error event 378, output from simulated memory agent 218′, and utilizes result checker 226 to match error event 378 to remaining expected events 328, 334 within memory read expectations 308. In the current example, result checker 226 fails to match error event 378 and generates one or more error messages (e.g., messages 312) indicating the erroneous event.

Result checker 226 then modifies remaining events 328, 334 of memory read expectations 308 to prevent cascading of error messages. In one example, result checker 226 sets a status of remaining events 328, 334 to ‘zombie’ to indicate that these events are ignored if observed, and further that these events do not generate error messages if not observed (i.e., a next event 384 of a next simulated transaction 380 next observed by checker 222′). Thus, by modifying the status of events within expectations 236 associated with simulated transaction 304, result checker 226 prevents further error generation for simulated transaction 304 while attempting continued synchronization for next simulated transaction 380. Remaining events 342, 356, 358 of simulated transaction 304 are matched with remaining event 334 of memory read expectations 308, if occurring, and do not generate further error messages should they not occur.

In another example of an error transaction, simulated memory agent 218′ prematurely sends transaction complete event 358 for simulated transaction 304. Checker 222′ observes transaction complete event 358 and uses result checker 226 to match transaction complete event 358 to transaction complete event 334 while expecting other events of simulated transaction 304. In this example, result checker 226 determines that simulated transaction 304 is not yet complete, and sends an error message (e.g., messages 312) to transaction and error log 238. Result checker 226 then resynchronizes with following transactions and events by identifying remaining expected events of memory read expectations 308 and sets a status of the identified events to zombie. Result checker 226 therefore recognizes events of simulated transaction 304, if occurring, and does not generate further error messages should further events of simulated transaction 304 not occur.

It should be apparent that the use of the zombie status within expectations 236 allows result checker 226 to maintain synchronization between simulator status 240′ and expectations 236 to prevent already detected errors from being repeated and cascaded. Transaction and error log 238 is thereby uncluttered by redundant and incorrect error messages, allowing the verification engineer to quickly determine real errors.

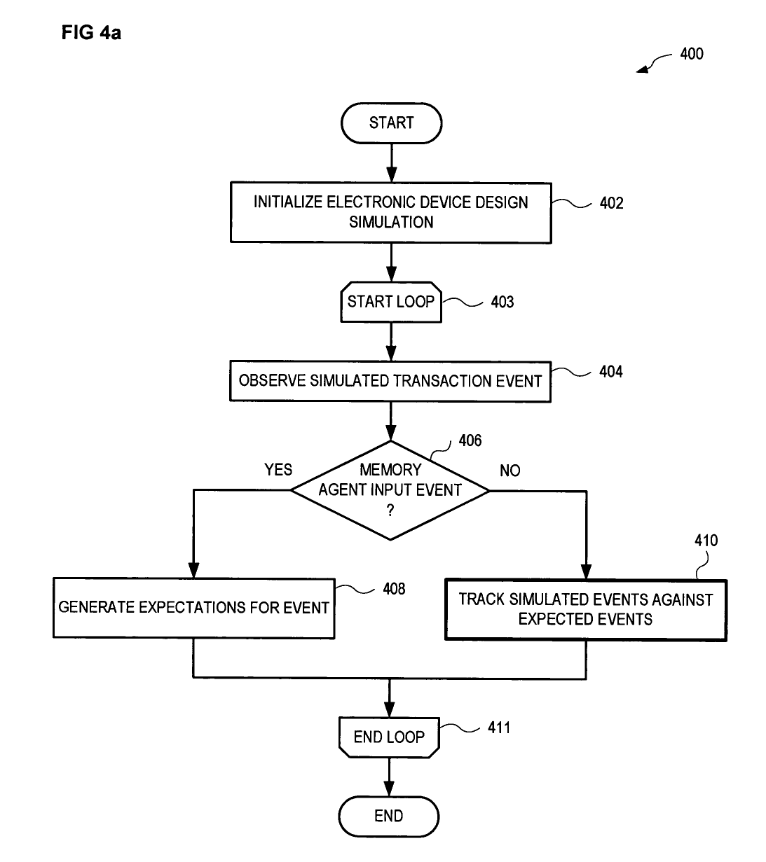

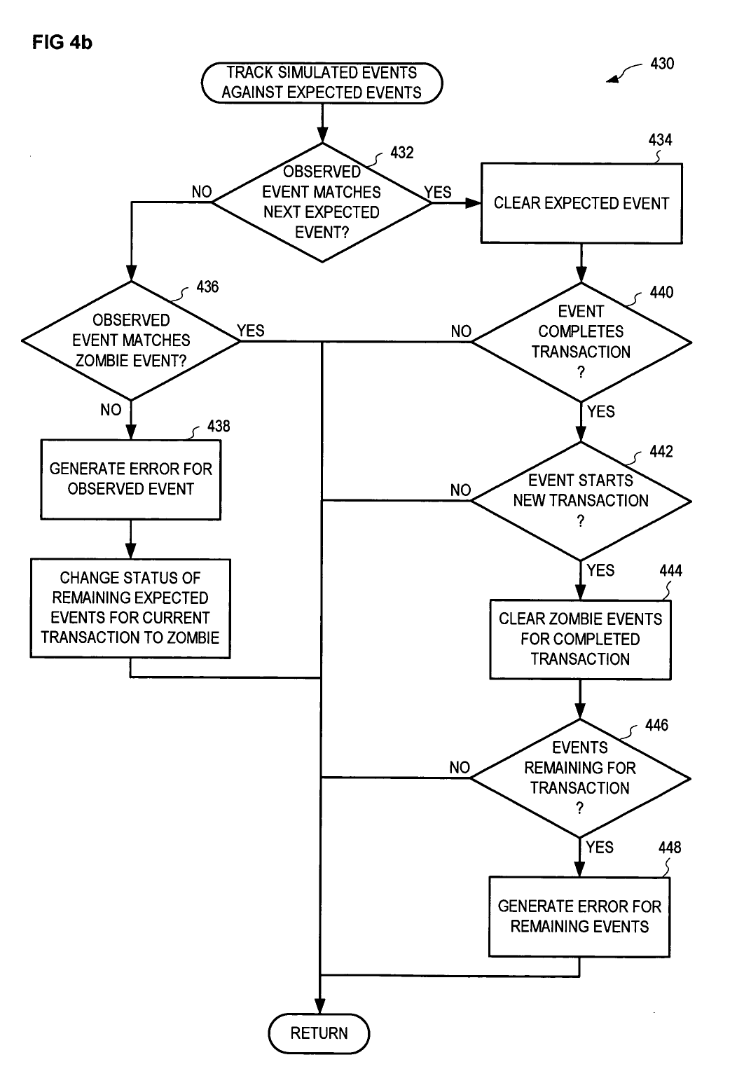

FIG. 4a is a flowchart illustrating one process 400 for error tracking and recovery in an expectation-based memory agent checker. Process 400 is, for example, implemented by simulator 220, expectation generator 224′ and result checker 226 of FIG. 3a. In step 402, process 400 initializes a simulation of an electronic device design. In one example of step 402, simulator 220 simulates electronic device design 216 as simulated electronic design 216′, creating simulated memory agents 218′, 314, 315, 316, a simulated cache memory 306 and simulated processing core 313. In step 404, process 400 observes events within simulator status 240′ resulting from stimulation of simulated electronic device design 216′ by one or more stimuli of stimuli events 232. For example, in step 404, process 400 observes memory read line event 320 of simulated transaction 304. Step 406 is a decision. In step 406, if the observed event of step 404 is an input event of simulated memory agent 218′, process 400 continues with step 408; otherwise process 400 continues with step 410. In step 408, process 400 generates expectations for the observed event of step 404. In one example of step 408, expectation generator 224′ processes memory read line event 320, observed in step 404, and generates memory read expectations 308 that define one or more of expected events of simulated transaction 304. In step 410, process 400 verifies observed events within simulator status 240′ against expected events of expectations 236. In one example of step 410, process 400 verifies observed events of simulated transaction 304 against memory read expectations 308. In step 410, process 400 verifies events of simulator status 240′ against expectations 236, using a process 430 of FIG. 4b. Process 430 may modify expectations 236 and send messages to transaction and error log 238. In one example of step 410, process 430 is implemented by result checker 226.

Steps 404, 406, 408 and 410 of process 400 are repeated one or more times as indicated by loop boundaries 403 and 411. For example, steps 404, 406, 408 and 410 are repeated for each observed event within simulator status 240′.

FIG. 4b illustrates one process 430 utilized in step 410 of process 400. In one embodiment, process 430 processes simulator status 240′ and expectations 236. Step 432 is a decision. In step 432, process 430 determines if the observed event of step 404, process 400, matches the next expected event within expectations 236. If the observed event matches the next expected event, process 430 continues with step 434; otherwise process 430 continues with step 436. In step 434, the matched expected event in expectations 236 is cleared. In one example of step 434, process 430 marks the matched expected event as complete, making the following expected event the next expected event.

Step 436 is a decision. In step 436, process 430 determines if the observed event matches an event with a zombie status within expectations 236. If the observed event matches a zombie event, process 430 returns control to process 400; otherwise process 430 continues with step 438. In step 438, process 430 sends an error message to transaction and error log 238, indicating that the observed event is unexpected. In step 439, process 430 modifies the status of expected events associated with the current transaction to zombie.

Step 440 is a decision. If, in step 440, the received event terminates the current transaction, process 430 continues with step 442; otherwise process 430 returns control to process 400. Step 442 is a decision. If, in step 442, process 430 determines that the observed event starts a new transaction, process 430 continues with step 444; otherwise process 430 returns control to process 400. In step 444, process 430 clears zombie events for the current or completed transaction. In one example of step 444, result checker 226 marks events associated with the current or completed transaction as complete. In another example of step 444, result checker 226 deletes events associated with the current or completed transaction.

Step 446 is a decision. If, in step 446, process 430 determines that expected events associated with the current or completed transaction are still expected, process 430 continues with step 448; otherwise process 430 returns control to process 400. In step 448, process 430 produces one or more warning messages indicating that expected events were not received for the current or completed transaction.

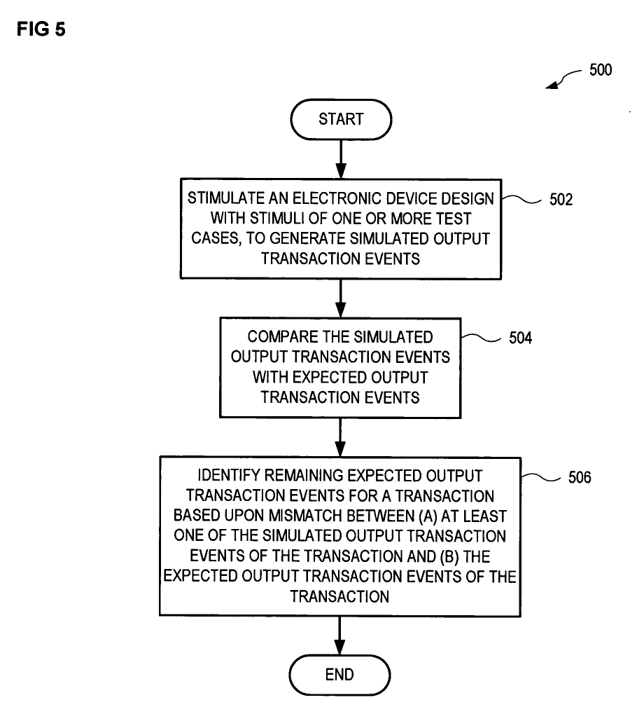

FIG. 5 is a flowchart illustrating one process 500 for error tracking and recovery in an expectation-based memory agent checker. Process 500 is, for example, implemented by checker 222, FIG. 2. In step 502, the simulated electronic device design is stimulated with stimuli of one or more test cases, to generate simulated output transaction events. In step 504, the simulated output transaction events are compared with expected output transaction events. In step 506, remaining expected output transaction events are identified for a transaction based upon mismatch between (a) at least one of the simulated output transaction events of the transaction and (b) the expected output transaction events of the transaction.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

1. A method for error tracking and recovery in an expectation-based memory agent checker, comprising:
stimulating an electronic device design with stimuli of one or more test cases, to simulate a transaction;
observing simulated events of the transaction;
comparing the observed simulated events with expected events;
identifying remaining expected events for the transaction based upon mismatch between at least one of the simulated events and the expected events.

2. The method of claim 1, further comprising generating the expected events based upon observed simulated events input to a simulated memory agent.

3. The method of claim 2, the step of generating comprising electronically processing the observed simulated event input to the simulated memory agent to determine the expected events.

4. The method of claim 2, the step of generating comprising utilizing user input as the expected events.

5. The method of claim 1, wherein the step of identifying comprises setting a status for the remaining expected events.

6. The method of claim 1, further comprising the step of generating an error message for the transaction based upon the mismatch.

7. The method of claim 1, the step of comparing comprising sequentially comparing the simulated events, until the mismatch occurs, with the expected events.

8. The method of claim 7, the step of comparing further comprising attempting synchronization after the mismatch by comparing and matching remaining simulated events with the remaining expected events.

9. The method of claim 1, the step of identifying comprising setting a status for each unmatched expected event, the status indicating that the unmatched expected event does not generate an error message.

10. The method of claim 9, the step of setting a status comprising setting the unmatched expected event to zombie.

11. The method of claim 1, further comprising the step of logging error messages for mismatches between the simulated events and the expected events unless the mismatches correspond to the identified remaining expected events.

12. The method of claim 1, further comprising the step of simulating the electronic device design.

13. A method for error tracking and recovery in an expectation-based memory agent checker, comprising:
stimulating an electronic device design with stimuli of one or more test cases to simulate a transaction;
observing simulated events of the transaction;
sequentially comparing the simulated events with expected events of the transaction;
if a mismatch occurs:
generating one error message for the mismatch;
identifying remaining expected events;
matching, if possible, unmatched simulated events to the identified remaining expected events;
matching, if possible, simulated events for a next transaction to expected events for the next transaction without comparison to the identified remaining expected events.

14. The method of claim 13, further comprising generating an error message for the mismatch.

15. The method of claim 13, wherein the step of identifying comprises setting a status for the remaining expected events.

16. A system for error tracking and recovery in an expectation-based memory agent checker, comprising:
one or more test cases containing stimuli;
an expectation generator for generating expected events based upon observed simulation events;
a simulator for simulating an electronic device design and generating simulated output transaction events;
a result checker for comparing simulated output transaction events and expected output transaction events, for identifying remaining expected output transaction events for a transaction when a mismatch occurs between the simulated output transaction events and expected output transaction events for the transaction, and for generating an error message for the mismatch; and
a transaction and error log for storing the error message.

17. The system of claim 16, the transaction and error log storing simulated transactions.

18. The system of claim 17, wherein transactions are stored for matches between the simulated output transaction events and the expected output transaction events, and wherein error messages are stored for unmatched expected output transaction events unless the expected output transaction event has been identified.

19. A system for error tracking and recovery in an expectation-based memory agent checker, comprising:
means for stimulating an electronic device design with stimuli of one or more test cases, to generate simulated output transaction events;
means for comparing the simulated output transaction events with expected output transaction events; and
means for identifying remaining expected output transaction events for a transaction based upon mismatch between (a) at least one of the simulated output transaction events of the transaction and (b) the expected output transaction events of the transaction.

20. The method of claim 19, wherein the means for identifying comprises means for setting a status for the remaining expected output transaction events.

21. A software product comprising instructions, stored on computer-readable media, wherein the instructions, when executed by a computer, perform steps for error tracking and recovery in an expectation-based memory agent checker, comprising:
instructions for stimulating a simulated electronic device design with stimuli of one or more test cases, to generate simulated output transaction events;
instructions for comparing the simulated output transaction events with expected output transaction events; and
instructions for identifying remaining expected output transaction events for a transaction based upon mismatch between (a) at least one of the simulated output transaction events of the transaction and (b) the expected output transaction events of the transaction.
